(19) United States
(12) Patent Application Publication
(10) Pub. No.: US 2025/0190477 A1
(43) Pub. Date: Jun. 12, 2025

(54) GRAPHICAL USER INTERFACE FOR PROVIDING PERFECTION DOCUMENTS USING A RULES ENGINE

(71) Applicant: Capital One Services, LLC, McLean, VA (US)

(72) Inventors: Kuldeep Kashinath MARGANACHE, Frisco, TX (US); Amanda Rae DORSEY, Prosper, TX (US); Anthony John MOSCARELLI, Anna, TX (US); Alexis DERROW, Dallas, TX (US); Matt HOANG, Richardson, TX (US); Jared D. FLEMING, McKinney, TX (US); Sriram SURESH, Dallas, TX (US)

(21) Appl. No.: 18/436,745

(22) Filed: Feb. 8, 2024

Related U.S. Application Data
(60) Provisional application No. 63/607,886, filed on Dec. 8, 2023.

(51) Int. Cl. G06F 16/35; G06F 40/134; G06F 40/166

(52) U.S. Cl. CPC G06F 16/358; G06F 40/134; G06F 40/166

(57) ABSTRACT

In some implementations, a device may obtain first information of a first document. The device may obtain second information of a second document. The device may determine, based on the first information, one or more base documents associated with modifying the first document to indicate the second document. The device may detect, based on a comparison of the first information to the second information, one or more perfection targets associated with modifying the first document to indicate the second document. The device may determine, based on the first information and the second information, one or more perfection documents for the one or more perfection targets, wherein the one or more perfection documents are provided by a first entity identified using the entity database. The device may provide an indication of the one or more base documents and the one or more perfection documents.

### CROSS-REFERENCE TO RELATED APPLICATION

This patent application claims priority to U.S. Provisional Patent Application No. 63/607,886, filed on Dec. 8, 2023, and entitled “GRAPHICAL USER INTERFACE FOR PROVIDING PERFECTION DOCUMENTS USING A RULES ENGINE.” The disclosure of the prior application is considered part of and is incorporated by reference into this patent application.

### BACKGROUND

A graphical user interface is a form of user interface that allows users to interact with electronic devices. A web browser or application may provide a graphical user interface that presents pages. A user may navigate to a page by entering an address into an address bar of the web browser and/or by clicking a link displayed via another page. Navigation to a page may consume resources of a client device on which the web browser is installed, may consume resources of a server that serves the page to the client device, and may consume network resources used for communications between the client device and the server.

### SUMMARY

Some implementations described herein relate to a system for collecting and providing perfection documents using a rules engine via a graphical user interface (GUI). The system may include one or more memories and one or more processors communicatively coupled to the one or more memories. The one or more processors may be configured to obtain, via the GUI, first information of a first document. The one or more processors may be configured to obtain, via the GUI, second information of a second document. The one or more processors may be configured to determine, based on the first information, one or more base documents associated with modifying the first document to indicate the second document. The one or more processors may be configured to detect, using the rules engine and based on a comparison of the first information to the second information, one or more perfection targets associated with modifying the first document. The one or more processors may be configured to determine, using an entity database and based on the first information and the second information, one or more perfection documents for the one or more perfection targets, wherein the one or more perfection documents are provided by a first entity identified using the entity database. The one or more processors may be configured to provide, via the GUI, an indication of the one or more base documents and the one or more perfection documents, wherein at least one of the one or more base documents or the one or more perfection documents are accessible via a graphical element of the GUI.

Some implementations described herein relate to a method for collecting and providing perfection documents via a rules engine. The method may include obtaining, by a device, first information of a first document. The method may include obtaining, by the device, second information of a second document. The method may include determining, by the device using the rules engine and based on the first information, one or more base documents associated with modifying the first document to indicate the second document. The method may include detecting, by the device using the rules engine and based on a comparison of the first information to the second information, one or more perfection targets associated with modifying the first document to indicate the second document. The method may include determining, by the device using an entity database and based on the first information and the second information, one or more perfection documents for the one or more perfection targets, wherein the one or more perfection documents are provided by a first entity identified using the entity database. The method may include providing, by the device, an indication of the one or more base documents and the one or more perfection documents.

Some implementations described herein relate to a non-transitory computer-readable medium that stores a set of instructions. The set of instructions, when executed by one or more processors of a device, may cause the device to obtain first information of a first document. The set of instructions, when executed by one or more processors of the device, may cause the device to obtain second information of a second document. The set of instructions, when executed by one or more processors of the device, may cause the device to determine, using a rules engine and based on the first information, one or more base documents associated with modifying the first document to indicate the second document. The set of instructions, when executed by one or more processors of the device, may cause the device to detect, using the rules engine and based on a comparison of the first information to the second information, one or more perfection targets associated with modifying the first document to indicate the second document. The set of instructions, when executed by one or more processors of the device, may cause the device to determine, using an entity database and based on the first information and the second information, one or more perfection documents for the one or more perfection targets, wherein the one or more perfection documents are provided by a first entity identified using the entity database. The set of instructions, when executed by one or more processors of the device, may cause the device to provide an indication of the one or more base documents and the one or more perfection documents.

### BRIEF DESCRIPTION OF THE DRAWINGS

FIGS. 1A-1C are diagrams of an example associated with a graphical user interface (GUI) for providing perfection documents using a rules engine, in accordance with some embodiments of the present disclosure.

FIG. 2 is a diagram illustrating an example of training and using a machine learning model in connection with a GUI for providing perfection documents using a rules engine, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with a GUI for providing perfection documents using a rules engine, in accordance with some embodiments of the present disclosure.

FIG. 5 is a flowchart of an example process associated with a GUI for providing perfection documents using a rules engine, in accordance with some embodiments of the present disclosure.

### DETAILED DESCRIPTION

The following detailed description of example implementations refers to the accompanying drawings. The same reference numbers in different drawings may identify the same or similar elements.

A user interface of a client device, such as a user interface provided by a web browser or an application and may include a page for presentation via the client device. The page may include hyperlinks to various other web pages in one or more navigational menus. Often, it may be difficult for a user to locate particular information of interest using a navigational menu. For example, descriptions of the navigational menu may be unintuitive and/or the user may need to click through navigational menus in multiple hierarchical levels in order to locate the information of interest. Navigating through a large number of web pages to find relevant information creates a poor user experience, consumes excessive computing resources (e.g., processing resources and memory resources) that are needed for the user device to generate and display the web pages and that are needed for one or more server devices to serve the web pages to the user device, and consumes excessive network resources that are needed for communications between the user device and the server device.

In some cases, a document may be modified to indicate other documents or interests associated with the document. However, identifying which documents are needed to modify the original document may be challenging. For example, regulatory and/or jurisdictional specific rules may define how and/or if the original document can be modified in different scenarios. For example, different jurisdictions may have different regulations regarding recording of the modification to the original document. Maintaining changes in jurisdictional rules and understanding jurisdiction-specific regulations is complex and time consuming. Additionally, it is difficult to determine the specific documents needed to modify the document(s) (e.g., referred to herein as “perfection documents”) when there are discrepancies between the original document and a document to be indicated and/or added to the original document. Identifying and rectifying discrepancies can be complex and time consuming and may require coordination between the different users, entities, and relevant government agencies, among other examples.

For example, a user may use a client device to navigate to multiple web pages for different jurisdictions to determine how and/or if the original document can be modified in different scenarios. This consumes computing resources (e.g., processing resources and memory resources) that are needed to navigate to the multiple web pages. Additionally, pages for a given jurisdiction may be unintuitive and/or the user may need to click through navigational menus in multiple hierarchical levels in order to locate the information of interest (e.g., to locate information indicative of how and/or if the original document can be modified in different scenarios). As a result, the user may be unable to identify the information of interest and/or the client device may consume computing resources associated with excessive navigation of the page.

Additionally, vast amounts of data may be stored electronically in data structures (e.g., databases, blockchains, log files, cookies, or other data structures). A device may perform multiple queries, or other information retrieval techniques, to unrelated data structures to obtain data relevant to a particular task or computational operation (e.g., to identify which documents are needed to modify an original document). Moreover, each data structure may employ a particular schema and/or use particular data formatting conventions for data storage. Thus, the data may be incompatible and difficult to integrate into machine-usable outputs for computational instructions or automation. This incompatibility may necessitate separate handling of the data using complex instructions and/or repetitive processing to achieve desired computational outcomes or automation outcomes, thereby expending significant computing resources (e.g., processor resources and/or memory resources) and causing significant delays.

In addition, separate use of the data, such as individually presenting the data in a user interface for analysis by a user, may be inefficient. For example, the device may separately process and/or reformat data from different data structures to obtain information for presenting in the user interface, thereby expending significant computing resources. Furthermore, individually presenting the data may increase the size of a user interface (e.g., a web page) or utilize multiple user interfaces (e.g., multiple web pages). Navigating through a large user interface or a large number of user interfaces to find relevant information creates a poor user experience, consumes excessive computing resources that are needed for a client device to generate and display the user interface(s) and that are needed for one or more server devices to serve the user interface(s) to the client device, and consumes excessive network resources that are needed for communications between the client device and the server device.

Some implementations described herein enable efficiently identifying and providing documents via a GUI for modifying an original document. Some implementations described herein enable integration of otherwise incompatible data from multiple unrelated data structures. For example, a device may use a rules engine to identify perfection documents needed to record modifications and/or updates to documents in different scenarios. For example, the rules engine may store one or more rules that map parameters indicated by ownership documents to information indicative of how and/or if the ownership documents can be modified to indicate other documents or information.

In some implementations, a device may obtain, via the GUI, first information of a first document. The first document may be a document that is to be modified and/or updated to indicate a second document. For example, the first document may be an ownership document, such as a title document (e.g., indicating ownership information of an item or building). The device may obtain, via the GUI, second information of a second document. The second document may be a loan document or a security agreement for the item associated with the first document. For example, the first document may be associated with recording ownership of the item, such as a vehicle or a home, among other examples. The device may determine, based on the first information, one or more base documents associated with modifying the first document to indicate the second document.

The device may detect, using the rules engine and based on a comparison of the first information to the second information, one or more perfection targets associated with modifying the first document. A perfection target may include an identified jurisdiction, one or more identified users, and a discrepancy to be addressed. For example, the device may use the rules engine to flag discrepancies to be addressed to enable the first document to be modified correctly and/or in an enforceable manner (e.g., by generating a modification flag to indicate that a perfection document is to be associated with addressing a difference or discrepancy). Additionally, the rules engine may include one or more rules to identify a jurisdiction in which the discrepancy is to be addressed. The device may determine, using an entity database and based on the first information and the second information, one or more perfection documents for the one or more perfection targets. For example, the one or more perfection documents are provided by a first entity (e.g., a government agency) identified using the entity database.

The device may provide, via the GUI, an indication of the one or more base documents and the one or more perfection documents. In some implementations, at least one of the one or more base documents or the one or more perfection documents are accessible via a graphical element of the GUI. For example, the rules engine may enable the device to quickly and accurately identify the documents needed to modify the first document (e.g., an ownership document) in an accurate and enforceable manner. The device may use the GUI to present the document(s) in an organized and centralized manner, enabling a user to identify and/or access all of the documents from a single page or interface.

In this way, computing resources and/or network resources may be conserved by reducing an amount of navigation performed by the user via a client device. Furthermore, the techniques described herein make data easier to access by enhancing a user interface, thereby improving a user experience, and/or enhancing user-friendliness of a client device and the user interface. Additionally, the rules engine improves the likelihood that all documents needed to modify a document (e.g., an ownership document) in an accurate and enforceable manner are quickly and accurately identified and/or obtained. This conserves processing resources, computing resources, and/or time that would have otherwise been associated with navigating different jurisdiction entity web pages to identify the document(s) and/or associated with needlessly performing one or more operations to modify the document without the base documents and/or perfection documents needed to modify the document in an enforceable manner.

In some implementations, the device may use a machine learning model to predict one or more base documents and one or more perfection documents associated with modifying the first document. For example, the machine learning model may determine the one or more base documents, the one or more perfection documents, and/or a perfection target based on data relating to the first document, an entity associated with the first document, and/or a user associated with the first document. Based on the one or more base documents and one or more perfection documents, the device may provide, via the GUI, an indication of the one or more base documents and the one or more perfection documents. In some implementations, at least one of the one or more base documents or the one or more perfection documents are accessible via a graphical element of the GUI.

In this way, the machine learning model enables the system to perform operations based on otherwise incompatible data while conserving computing resources and reducing delays that would otherwise result from separate handling of the data using complex instructions and/or repetitive processing. Moreover, an output of the machine learning model may convey data from the multiple unrelated databases in a smaller user interface or in a lesser number of user interfaces than otherwise would have been used to individually present data from the multiple unrelated databases. In this way, the use of computing resources and network resources is reduced in connection with serving, generating, and/or displaying the user interface(s).

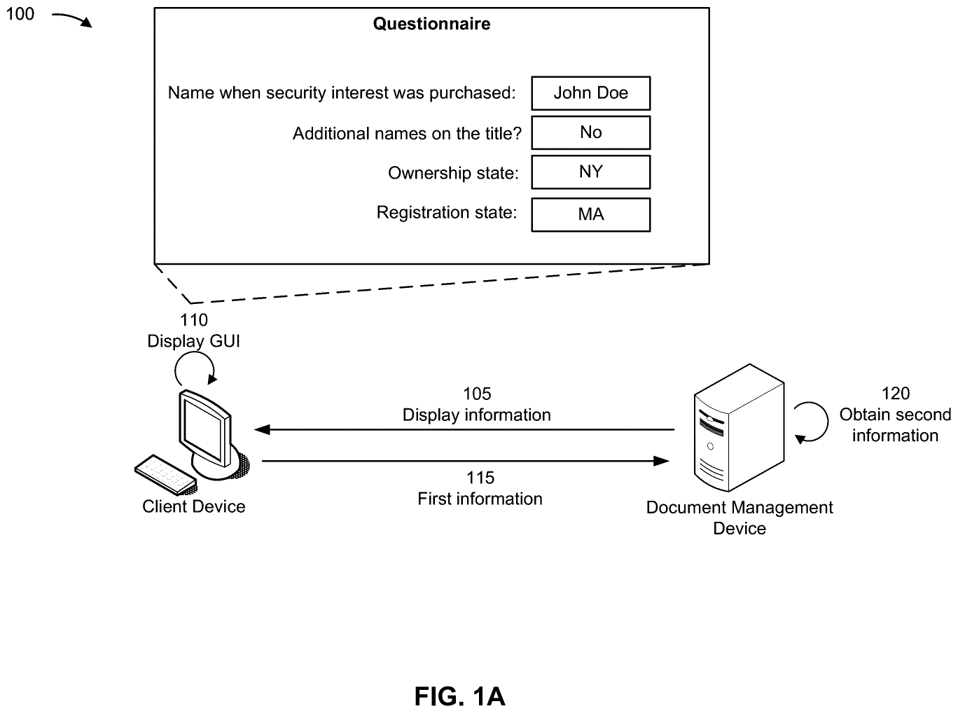

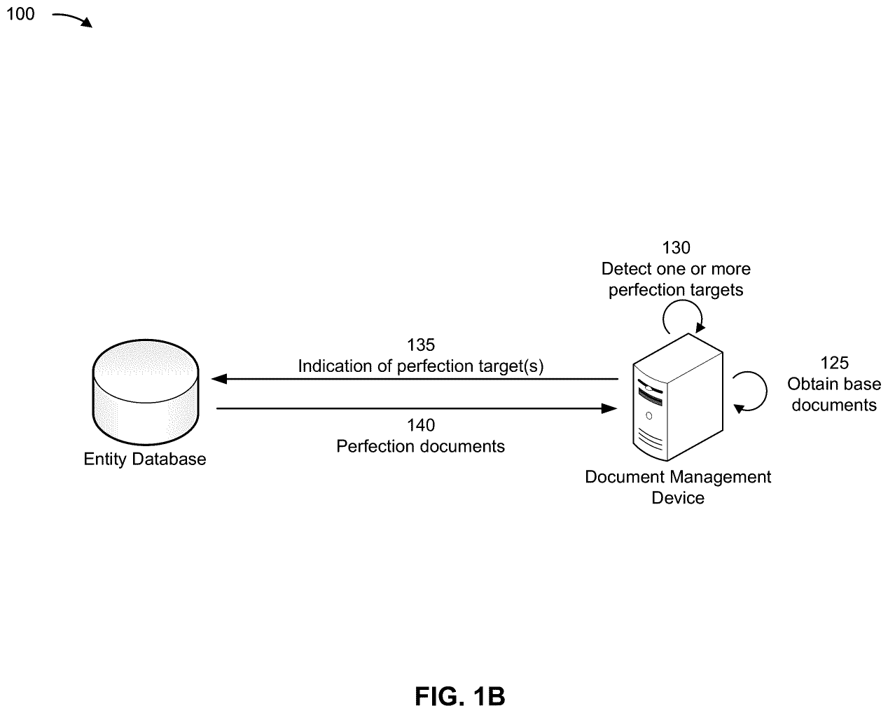

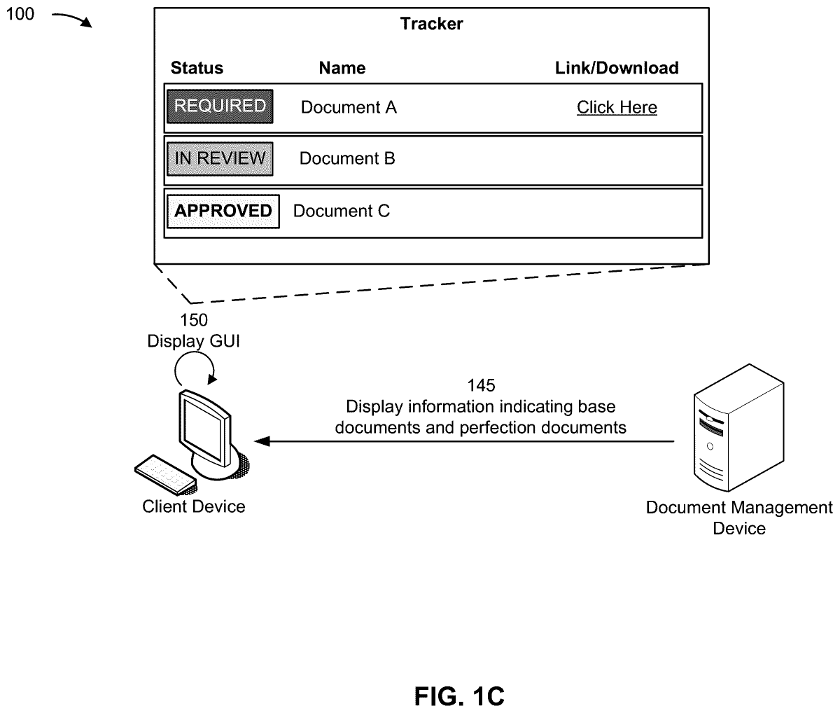

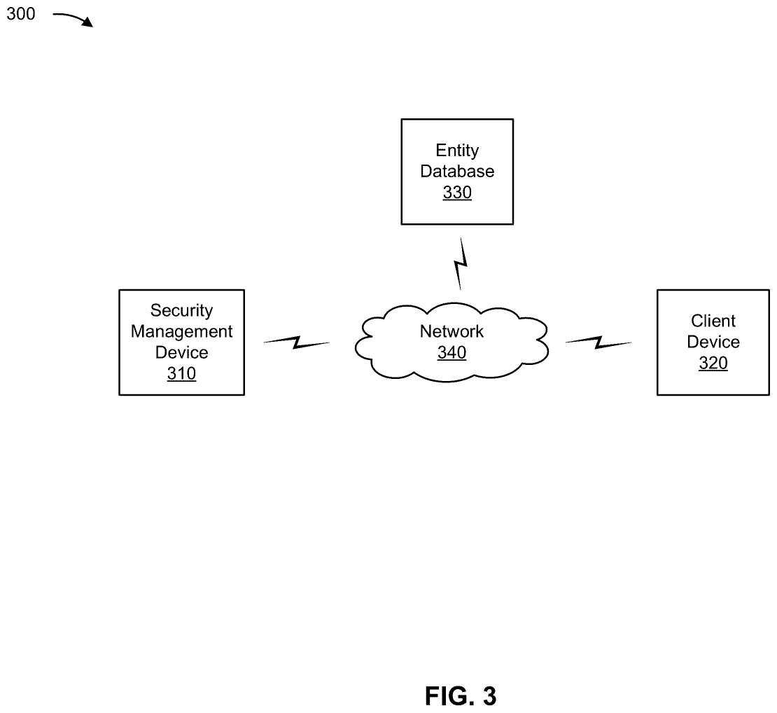

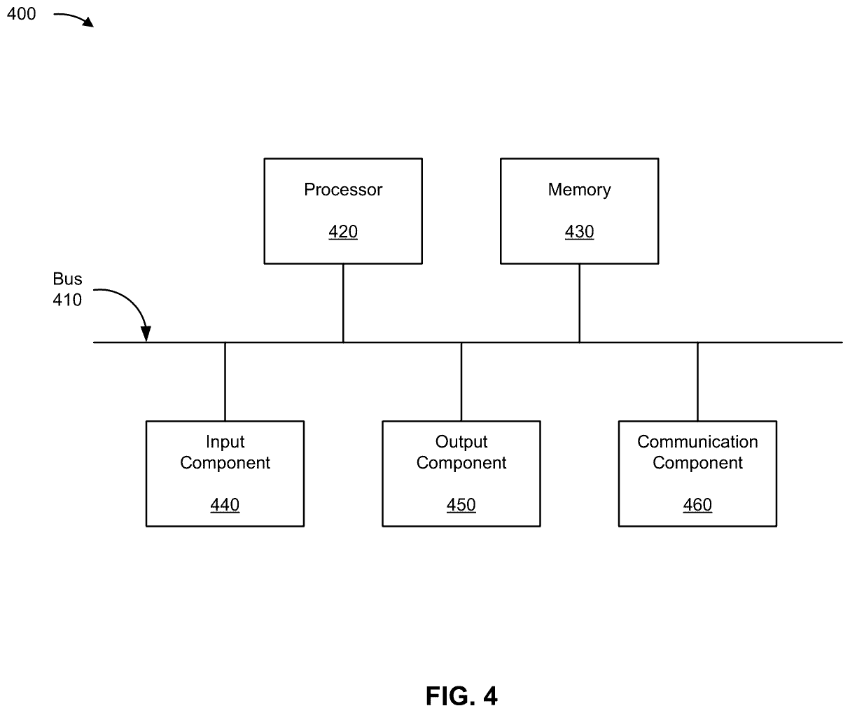

FIGS. 1A-1C are diagrams of an example 100 associated with a GUI for providing perfection documents using a rules engine. As shown in FIGS. 1A-1C, example 100 includes a document management device, a client device, and an entity database. These devices are described in more detail in connection with FIGS. 3 and 4.

The document management device may be configured to determine, obtain, and/or provide documents (e.g., base documents and/or perfection documents) for modifying a first document to indicate or include a second document (e.g., in an enforceable manner, such as by following guidelines or regulations of a given jurisdiction). As used herein, a “base” document refers to a document that is associated with modifying or updating a type of document (e.g., an ownership document) following the guidelines or regulations of a given jurisdiction. As used herein, a “perfection” document refers to a document that is associated with addressing or remedying a discrepancy in information that is used to modify of update the type of document.

The document management device may include, or be associated with, a rules engine. The rule engine may be a component configured to execute and/or manage one or more rules in an automated and consistent manner. The rules engine may store and/or manage one or more rules via a centralized repository (e.g., that may be organized hierarchically or categorically, allowing for easy retrieval and maintenance of rules). For example, the rules engine may store rules organized by different jurisdictions (e.g., different states). The rules engine may include an inference engine configure to execute and/or evaluate rules. The inference engine may be configured to interpret defined rules, apply the rules to data or event, and infer an appropriate outcome or action based on conditions specified in the rules.

For example, a rule may map a parameter of one or more documents to a regulation or requirement of one or more jurisdictions or entities. As an example, if a document is associated with an ownership of a vehicle (e.g., a title), a rule may map a parameter of the title document to a regulation or requirement of one or more department of motor vehicle (DMV) offices. For example, the rule may indicate one or more documents to be recorded in order to successfully modify the title document to indicate another document or interest, such as a loan document or a lien. For example, the rules engine may be configured to identify all the necessary legal steps to establish, document, and enforce a security interest or lien on a particular asset, such as a vehicle.

As shown in FIG. 1A, and by reference number 105, the document management device may transmit, and the client device may receive, display information. The display information may include user interface information that is configured to cause the client device to display a user interface. In some implementations, the display information may identify one or more graphical elements for inputting parameters associated with one or more documents (e.g., an ownership document, such as a title document). For example, the display information may cause the client device to display a questionnaire associated with collection information for a first document (e.g., that is to be modified to indicate a second document). The display information may be based on the second document. For example, the display information may be configured to cause the client device to display graphical elements associated with collecting information that is needed to modify the first document to indicate the second document. For example, based on a document type of the second document, different rules may be defined for what information is needed and/or what documents are needed to modify the first document.

As shown by reference number 110, the client device may display a GUI. For example, based on receiving the display information, the client device may display a GUI that includes one or more graphical elements associated with collecting information for the first document. For example, as shown in FIG. 1A, the GUI may include graphical elements and/or fields associated with a name of a user, whether there are any additional users associated with the first document (e.g., “Additional names on the title?”), and/or one or more graphical elements or fields for jurisdictions associated with the first document (e.g., an ownership state (or title state) and a registration state (e.g., a jurisdiction in which a vehicle is registered)).

As shown by reference number 115, the client device may transmit, and the document management device may receive or obtain, first information associated with the first document. The first information may be obtained via one or more inputs to the GUI (e.g., that is displayed by the client device). Additionally, or alternatively, the first information may be obtained via another device, such as a server device. For example, an identifier of an item or asset associated with the first document may be used to obtain the first information. For example, if the item or asset of a vehicle, then the identifier may be a vehicle identification number (VIN). The client device and/or the document management device may transmit, and one or more server devices may receive, the identifier. The one or more server devices may identify the first information using the identifier. The one or more server devices may transmit, and the document management device may receive, the first information. The first information may include one or more users (e.g., one or more owners of an asset and their legal names), one or more jurisdictions (e.g., one or more jurisdictions in which an ownership document is recorded and/or in which the item or asset is registered).

As shown by reference number 120, the document management device may obtain second information. The second information may be associated with a second document. The second document may be a basis for modifying the first document. For example, the second document may be a security agreement (e.g., a loan agreement) associated with an item or asset indicated by the first document. As an example, the second document may be a loan agreement that uses the item or asset as collateral.

The document management device may obtain the second information via memory and/or another device. The second information may indicate a user (e.g., a name of the user) and/or a jurisdiction associated with the second document.

As shown in FIG. 1B, and by reference number 125, the document management device may obtain one or more base documents. For example, the document management device may determine, based on the first information, one or more base documents associated with modifying the first document to indicate the second document. In some implementations, the document management device may use the rule engine to determine the one or more base documents. For example, the document management device may input the first information and the second information into the rules engine. The rules engine may output an indication of a jurisdiction in which the modification or update to the first document is to be recorded. The document management device may use the entity database to determine the one or more base documents indicated as being needed to modify the first document in the jurisdiction.

As shown by reference number 130, the document management device may detect one or more perfection targets. A perfection target may refer to a discrepancy to be updated in order to accurately and/or enforceably modify or update the first document. For example, the document management device may detect, using the rules engine and based on a comparison of the first information to the second information, one or more perfection targets associated with modifying the first document. In some implementations, the document management device may use a machine learning model to detect the one or more perfection targets. The machine learning model may recommend set of documents (e.g., perfection documents) to perfect the first document based on one or more training parameters.

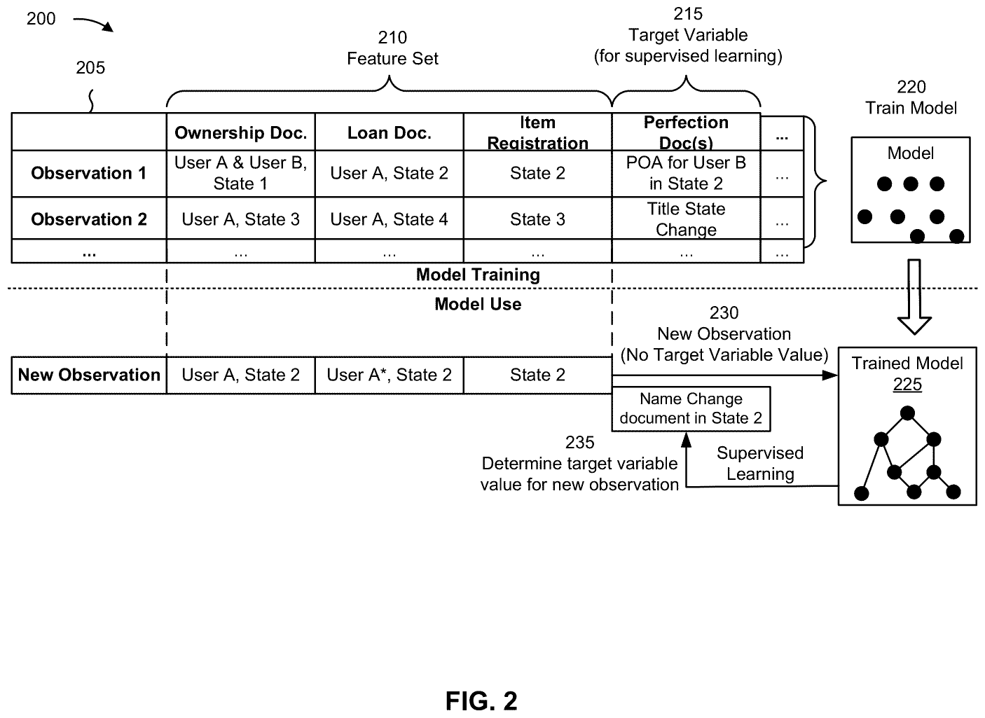

The machine learning model training and usage described herein may be performed using a machine learning system. The machine learning system may include or may be included in a computing device, a server, a cloud computing environment, or the like, such as the document management device. a machine learning model may be trained using a set of observations. The set of observations may be obtained from training data (e.g., historical data), such as data gathered during one or more processes described herein, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input. The machine learning system may identify a feature set (e.g., one or more features and/or feature values) by extracting the feature set from structured data, by performing natural language processing to extract the feature set from unstructured data, and/or by receiving input from an operator. The machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model to be used to analyze new observations. The training and use of the machine learning model is described in more detail in connection with FIG. 2.

As an example, a perfection target may include information to be corrected, a target jurisdiction in which modifying the first document to indicate the second document is to occur, and one or more users of the first document. For example, a perfection target may be associated with a mismatch in a name between the first document and the second document. As an example, a user's name may change between the time at which the first document is executed and the time at which the second document is executed. In order to enforceable modify the first document, a jurisdiction may require a perfection document to be recorded indicating the name change. As another example, a state in which the first document is recorded and a state in which the item or asset is registered may be different (e.g., an ownership-registration mismatch). Some jurisdictions may not permit the first document to be modified with an ownership-registration mismatch, whereas other jurisdictions may permit the first document to be modified with an ownership-registration mismatch. In such examples, a perfection document may include a document to change the jurisdiction in which the first document is recorded, or a document to change a jurisdiction in which the item or asset is registered.

The document management device may detect a perfection target via determining a difference between a parameter as indicated by first information (e.g., associated with the first document) and the parameter as indicated by the second information (e.g., associated with the second document). As an example, the first information may indicate that a user has a first name and the second information may indicate that the user has a second name (e.g., a name mismatch). As another example, the first information may indicate that the first document is executed by a first one or more users and the second information may indicate that the second document is executed by a second one or more users. The mismatch or difference in values of the parameter (e.g., between the first information and the second information) may be indicative of a perfection target for modifying the first document, as described herein.

In some implementations, the document management device may detect the perfection target based on, in response to, or otherwise associated with the mismatch or difference in values of the parameter (e.g., between the first information and the second information) being for a non-discretionary parameter. As used herein, a “non-discretionary” parameter may refer to a parameter that indicates information that is required or otherwise needed to be consistent across the first document and the second document in order to successfully perform the modification of the first document. For example, a non-discretionary parameter may include a name of a user (e.g., the name of the user may need to be the same across both documents), and/or registered owners of an item (e.g., associated with the first document) and users associated with the second document being the same, among other examples.

In some implementations, the document management device may provide, for display, graphical elements for inputting one or more non-discretionary parameters for modifying the first document to indicate the second document (e.g., when providing the display information described in connection with reference number 105). This may reduce a size of the display information and/or reduce an amount of information collected via the GUI (e.g., because only information for the non-discretionary parameter(s) is collected), thereby conserving computing resources, network resources, and/or memory resources that would have otherwise been associated with providing display information and/or collecting information for additional parameters that are not required for the modification of the first document to be performed successfully. Additionally, this may reduce an amount of data to be analyzed by the document management device when detecting the perfection target(s), thereby conserving computing resources, network resources, and/or memory resources that would have otherwise been associated with analyzing information that is not required for the modification of the first document to be performed successfully.

As shown by reference number 135, the document management device may provide, to the entity database, an indication of the one or more perfection targets. As shown by reference number 140, the entity database may return an indication of one or more perfection documents. For example, the entity database may store a mapping between a perfection target and one or more perfection documents (e.g., for respective jurisdictions). The document management device may use the entity database to identify the one or more perfection documents needed to address or resolve identified discrepancies between the first information and the second information.

As shown in FIG. 1C, and by reference number 145, the document management device may transmit, and the client device may receive, display information indicating the one or more base documents and the one or more perfection documents. In some implementations, the document management device may insert code in the display information to cause identifiers of a status of each document to be displayed via the GUI. As shown by reference number 150, the client device may display the GUI. For example, the document management device (via transmitting the display information) may provide, via the GUI, an indication of the one or more base documents and the one or more perfection documents. As shown in FIG. 1C, the one or more documents may include a document A, a document B, and a document C. The GUI may include graphical elements identifying a status of each document, such as “Required” (e.g., indicating that the document is required and has not been received), “In Review” (e.g., indicating that the document has been received, but not yet approved), and/or “Approved” (e.g., indicating that the document has been received and approved), among other examples.

In some implementations, at least one of the documents may be accessible via the GUI. For example, the GUI may include a hyperlink to enable the document to be downloaded via the client device and/or to enable the client device to navigate directly to a page at which the document can be accessed. This reduces computing resources that would have otherwise been associated with using the client device to navigate through multiple pages or websites to identify and access the document.

In some implementations, the document management device may cause a notification document to be provided indicating the one or more base documents and/or the one or more perfection documents. The notification document may be a physical letter, an email correspondence, an email attachment, and/or another document. The notification document may include status indications of respective documents in a similar manner as the GUI. As a result, a user may be enabled to quickly and easily identify the documents needed to modify or update the first document in an accurate and/or enforceable manner. This conserves processing resources, computing resources, and/or network resources, among other examples, that would have otherwise been associated with navigating to multiple web pages, and/or navigating through menus in multiple hierarchical levels in order to locate the information of interest (e.g., to locate information indicative of how and/or if the original document can be modified in different scenarios), among other examples.

In some implementations, the document management device may obtain one or more submitted documents (e.g., perfection documents that have been submitted) that have been completed and/or executed. For example, the client device may obtain the one or more submitted documents (e.g., a user may upload or submit the submitted documents via the GUI). The client device may analyze (e.g., using natural language processing or computer vision) the submitted documents to determine if the documents have been completed and/or executed correctly. In some implementations, the document management device may communicate with a server device associated with an entity in a given jurisdiction to provide the one or more submitted documents. For example, based on, in response to, or otherwise associated with obtaining the one or more submitted documents and the one or more submitted documents being correctly completed and/or executed, the document management device may be configured to communicate with one or more other devices (e.g., server devices) to cause the one or more submitted documents to be recorded and/or registered at an entity or agency in a given jurisdiction.

As indicated above, FIGS. 1A-1C are provided as an example. Other examples may differ from what is described with regard to FIGS. 1A-1C.

FIG. 2 is a diagram illustrating an example 200 of training and using a machine learning model in connection with a GUI for providing perfection documents using a rules engine. The machine learning model training and usage described herein may be performed using a machine learning system. The machine learning system may include or may be included in a computing device, a server, a cloud computing environment, or the like, such as the document management device or the client device described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the document management device and/or the client device, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the document management device or the client device. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of ownership document name and state (shown as “Ownership Doc.” in FIG. 2), a second feature of loan document name and state (shown as “Loan Doc.” in FIG. 2), a third feature of item registration state, and so on. As shown, for a first observation, the first feature may have a value of User A & User B, State 1 (e.g., indicating that the ownership document is executed by the user A and the User B in the State 1), the second feature may have a value of User A, State 2 (e.g., indicating that the loan document is executed by the user A in the State 2), the third feature may have a value of State 2 (e.g., indicating that the item associated with the ownership and loan documents is registered in the State 2), and so on. These features and feature values are provided as examples, and may differ in other examples. For example, although “state” is used herein as an example jurisdiction, other types of jurisdictions may be used, such as county, city, and/or country, among other examples. The feature set may include one or more of the following features: item title state (e.g., the state in which a title of the item is registered), user location (e.g., an address where a user currently lives), and/or entity location (e.g., a location associated with an entity that is a party to the loan document or another document), among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is perfection document(s), which has a value of power of attorney (POA) for the user B in the State 2 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. For example, a decision tree algorithm may effectively identify a correct document(s) (e.g., base documents and/or perfection documents) by sequentially applying a set of rules (e.g., from the rules engine) represented as branches in a tree. The decision tree algorithm may evaluate specific criteria at each decision node, guiding the process towards the correct document classification based on the features and conditions specified in the rules. As another example, a neural network algorithm may learn patterns and features from the data to make predictions. The rules engine can define additional criteria or constraints to fine-tune the document identification process, combining the adaptability of neural networks with predefined rules for a more accurate and controlled classification of documents. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of ownership document name and state (shown as “Ownership Doc.” in FIG. 2), a second feature of loan document name and state (shown as “Loan Doc.” in FIG. 2), a third feature of item registration state, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of “name change document in State 2” for the target variable of perfection documents for the new observation, as shown by reference number 235 (e.g., because the user's name may have changed from A to A*). Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, obtain and/or submit the name change document with an entity or agency in State 2. The first automated action may include, for example, parse a database associated with the entity or agency in State 2 to identify and/or obtain the name change document and/or to generate an element of a GUI that is selectable to cause a device (e.g., the client device) to navigate to a location where the name change document is accessible.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

The recommendations, actions, and clusters described above are provided as examples, and other examples may differ from what is described above. For example, the machine learning model 225 may be trained to predict values for a target variable of a level of effort parameter. The value of the level of effort parameter may be indicative of a difficulty or amount of effort associated with perfecting a document in a given jurisdiction (e.g., a given state). For example, machine learning model 225 may be trained to predict values level of effort parameter using a feature set of ownership document jurisdiction, loan document jurisdiction, user location, and/or item registration jurisdiction, among other examples. The recommendations associated with the level of effort parameter may include, for example, whether to perform an action associated with modifying a document (e.g., perfecting a document in a given jurisdiction), and/or a recommended jurisdiction in which to perform the action (e.g., based on the recommended jurisdiction having a value of the level of effort parameter indicating that the action will take the least effort in the recommended jurisdiction). The actions associated with the level of effort parameter may include, for example, obtaining one or more documents associated with the recommended jurisdiction.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model).

In this way, the machine learning system may apply a rigorous and automated process to determine, obtain, and/or provide one or more documents associated with modifying a given document. The machine learning system may enable recognition and/or identification of tens, hundreds, thousands, or millions of features and/or feature values for tens, hundreds, thousands, or millions of observations, thereby increasing accuracy and consistency and reducing delay associated with determining, obtaining, and/or providing one or more documents associated with modifying a given document relative to requiring computing resources to be allocated for tens, hundreds, or thousands of operators to manually determine, obtain, and/or provide one or more documents associated with modifying a given document using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a document management device 310, a client device 320, an entity database 330, and a network 340. Devices of environment 300 may interconnect via wired connections, wireless connections, or a combination of wired and wireless connections.

The document management device 310 may include one or more devices capable of receiving, generating, storing, processing, providing, and/or routing information associated with a GUI for providing perfection documents using a rules engine, as described elsewhere herein. The document management device 310 may include a communication device and/or a computing device. For example, the document management device 310 may include a server, such as an application server, a client server, a web server, a database server, a host server, a proxy server, a virtual server (e.g., executing on computing hardware), or a server in a cloud computing system. In some implementations, the document management device 310 may include computing hardware used in a cloud computing environment.

The client device 320 may include one or more devices capable of receiving, generating, storing, processing, and/or providing information associated with a GUI for providing perfection documents using a rules engine, as described elsewhere herein. The client device 320 may include a communication device and/or a computing device. For example, the client device 320 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The entity database 330 may include one or more devices capable of receiving, generating, storing, processing, and/or providing information associated with a GUI for providing perfection documents using a rules engine, as described elsewhere herein. The entity database 330 may include a communication device and/or a computing device. For example, the entity database 330 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the entity database 330 may store indications of perfection documents that are mapped to different scenarios or rules detected via the rules engine, as described elsewhere herein.

The network 340 may include one or more wired and/or wireless networks. For example, the network 340 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 340 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with a GUI for providing perfection documents using a rules engine. The device 400 may correspond to the document management device 310, the client device 320, and/or the entity database 330. In some implementations, the document management device 310, the client device 320, and/or the entity database 330 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

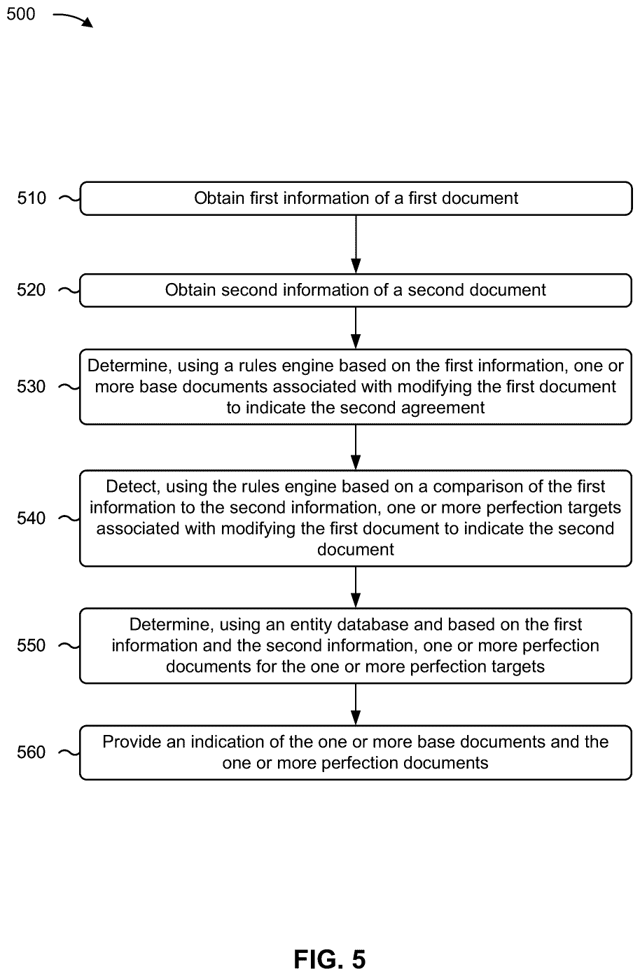

FIG. 5 is a flowchart of an example process 500 associated with a GUI for providing perfection documents using a rules engine. In some implementations, one or more process blocks of FIG. 5 are performed by a device (e.g., the document management device 310). In some implementations, one or more process blocks of FIG. 5 are performed by another device or a group of devices separate from or including the device, such as a client device (e.g., the client device 320), and/or a database (e.g., the entity database 330). Additionally, or alternatively, one or more process blocks of FIG. 5 may be performed by one or more components of device 400, such as processor 420, memory 430, input component 440, output component 450, and/or communication component 460.

As shown in FIG. 5, process 500 may include obtaining first information of a first document (block 510). For example, the device may obtain first information of a first document, as described above.

As further shown in FIG. 5, process 500 may include obtaining second information of a second document (block 520). For example, the device may obtain second information of a second document, as described above.

As further shown in FIG. 5, process 500 may include determining, based on the first information, one or more base documents associated with modifying the first document to indicate the second document (block 530). For example, the device may determine, based on the first information, one or more base documents associated with modifying the first document to indicate the second document, as described above.

As further shown in FIG. 5, process 500 may include detecting, based on a comparison of the first information to the second information, one or more perfection targets associated with modifying the first document to indicate the second document (block 540). For example, the device may detect, based on a comparison of the first information to the second information, one or more perfection targets associated with modifying the first document to indicate the second document, as described above.

As further shown in FIG. 5, process 500 may include determining, based on the first information and the second information, one or more perfection documents for the one or more perfection targets (block 550). For example, the device may determine, based on the first information and the second information, one or more perfection documents for the one or more perfection targets, as described above. In some implementations, the one or more perfection documents are provided by a first entity identified using the entity database.

As further shown in FIG. 5, process 500 may include providing an indication of the one or more base documents and the one or more perfection documents (block 560). For example, the device may provide an indication of the one or more base documents and the one or more perfection documents, as described above.

Process 500 may include additional implementations, such as any single implementation or any combination of implementations described below and/or in connection with one or more other processes described elsewhere herein.

In a first implementation, detecting the one or more perfection targets includes determining a difference between a parameter as indicated by the first information and the parameter as indicated by the second information.

In a second implementation, alone or in combination with the first implementation, the parameter is a non-discretionary parameter for modifying the first document to indicate the second document via the first entity.

In a third implementation, alone or in combination with one or more of the first and second implementations, obtaining the first information includes providing, for display, graphical elements for inputting one or more non-discretionary parameters for modifying the first document to indicate the second document.

In a fourth implementation, alone or in combination with one or more of the first through third implementations, obtaining the first information includes providing, to one or more server devices, an identifier of an item associated with the first document, and obtaining, from the one or more server devices, the first information.

In a fifth implementation, alone or in combination with one or more of the first through fourth implementations, the first entity is associated with a first jurisdiction, and detecting the one or more perfection targets includes determining that the first information indicates that the first document is associated with the first jurisdiction and that an item associated with the first document is registered with a second jurisdiction, and determining that the first entity is to be associated with the one or more perfection documents based on a level of effort parameter for modifying the first document to indicate the second document associated with the one or more perfection documents associated with the first entity and the first jurisdiction, and another one or more perfection documents associated with a second entity and the second jurisdiction.

In a sixth implementation, alone or in combination with one or more of the first through fifth implementations, the one or more perfection targets include at least one of a target jurisdiction in which modifying the first document to indicate the second document is to occur, or one or more users associated with the first document.

In a seventh implementation, alone or in combination with one or more of the first through sixth implementations, the one or more perfection documents include at least one of a name change document, an ownership jurisdiction change document, or a registration jurisdiction change document.

In an eighth implementation, alone or in combination with one or more of the first through seventh implementations, process 500 includes determining a difference between a parameter as indicated by the first information and the parameter as indicated by the second information, and generating a modification flag to indicate that a perfection document, of the one or more perfection documents, is to be associated with addressing the difference.

In a ninth implementation, alone or in combination with one or more of the first through eighth implementations, detecting the one or more perfection targets includes determining that at least one of the first information indicates that the first document is associated with a first jurisdiction and that an item associated with the first document is registered with a second jurisdiction, or the second information indicates that the second information is associated with the second jurisdiction or a third jurisdiction, and determining the first entity based on the first entity being associated with the first jurisdiction if the entity database indicates that the first jurisdiction permits modifying the first document to indicate the second document with an ownership-registration jurisdiction mismatch or an ownership-security jurisdiction mismatch, or the first entity being associated with the second jurisdiction or the third jurisdiction if the entity database indicates that the first jurisdiction does not permit modifying the first document to indicate the second document with the ownership-registration jurisdiction mismatch or the ownership-security jurisdiction mismatch.

In a tenth implementation, alone or in combination with one or more of the first through ninth implementations, providing the indication of the one or more base documents and the one or more perfection documents includes causing a notification document to be mailed, wherein the notification document includes the indication of the one or more base documents and the one or more perfection documents.

In an eleventh implementation, alone or in combination with one or more of the first through tenth implementations, the first document is an ownership document and the second document is a security agreement.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for collecting and providing perfection documents using a rules engine via a graphical user interface (GUI), the system comprising:
one or more memories; and
one or more processors, communicatively coupled to the one or more memories, configured to:
obtain, via the GUI, first information of a first document;
obtain, via the GUI, second information of a second document;
determine, based on the first information, one or more base documents associated with modifying the first document to indicate the second document;
detect, using the rules engine and based on a comparison of the first information to the second information, one or more perfection targets associated with modifying the first document;
determine, using an entity database and based on the first information and the second information, one or more perfection documents for the one or more perfection targets,
wherein the one or more perfection documents are provided by a first entity identified using the entity database; and
provide, via the GUI, an indication of the one or more base documents and the one or more perfection documents,
wherein at least one of the one or more base documents or the one or more perfection documents are accessible via a graphical element of the GUI.

2. The system of claim 1, wherein the one or more processors, to detect the one or more perfection targets, are configured to:
determine a difference between a parameter an indicated by the first information and the parameter as indicated by the second information.

3. The system of claim 2, wherein the parameter is a non-discretionary parameter for modifying the first document to indicate the second document via the first entity.

4. The system of claim 1, wherein the one or more processors, to obtain the first information, are configured to:
provide, for display via the GUI, graphical elements for inputting one or more non-discretionary parameters for modifying the first document to indicate the second document.

5. The system of claim 1, wherein the one or more processors, to obtain the first information, are configured to:
provide, to one or more server devices, an identifier of an item associated with the first document; and
obtain, from the one or more server devices, the first information.

6. The system of claim 1, wherein the first entity is associated with a first jurisdiction, and wherein the one or more processors, to detect the one or more perfection targets, are configured to:
determine that the first information indicates that the first document is associated with the first jurisdiction and that an item associated with the first document is registered with a second jurisdiction; and
determine that the first entity is to be associated with the one or more perfection documents based on a level of effort parameter for modifying the first document to indicate the second document associated with:
the one or more perfection documents associated with the first entity and the first jurisdiction, and
another one or more perfection documents associated with a second entity and the second jurisdiction.

7. The system of claim 1, wherein the one or more perfection targets include at least one of:
a target jurisdiction in which modifying the first document to indicate the second document is to occur, or
one or more users of the first document.

8. The system of claim 1, wherein the one or more processors, to detect the one or more perfection targets, are configured to:
determine a difference between a parameter and indicated by the first information and the parameter as indicated by the second information; and
generate a modification flag to indicate that a perfection document, of the one or more perfection documents, is to be associated with addressing the difference.

9. The system of claim 1, wherein the one or more processors, to detect the one or more perfection targets, are configured to:
determine that at least one of:
the first information indicates that the first document is associated with a first jurisdiction and that an item associated with the first document is registered with a second jurisdiction, or
the second information indicates that the second information is associated with the second jurisdiction or a third jurisdiction; and
determine the first entity based on:
the first entity being associated with the first jurisdiction if the entity database indicates that the first jurisdiction permits modifying the first document to indicate the second document with an ownership-registration jurisdiction mismatch or an ownership-security jurisdiction mismatch, or
the first entity being associated with the second jurisdiction or the third jurisdiction if the entity database indicates that the first jurisdiction does not permit modifying the first document to indicate the second document with the ownership-registration jurisdiction mismatch or the ownership-security jurisdiction mismatch.

10. A method for collecting and providing perfection documents via a rules engine, comprising:
obtaining, by a device, first information of a first document;
obtaining, by the device, second information of a second document;
determining, by the device using the rules engine and based on the first information, one or more base documents associated with modifying the first document to indicate the second document;
detecting, by the device using the rules engine and based on a comparison of the first information to the second information, one or more perfection targets associated with modifying the first document to indicate the second document;
determining, by the device using an entity database and based on the first information and the second information, one or more perfection documents for the one or more perfection targets,
wherein the one or more perfection documents are provided by a first entity identified using the entity database; and
providing, by the device, an indication of the one or more base documents and the one or more perfection documents.

11. The method of claim 10, wherein detecting the one or more perfection targets comprises:
determining a difference between a parameter as indicated by the first information and the parameter as indicated by the second information.

12. The method of claim 11, wherein the parameter is a non-discretionary parameter for modifying the first document to indicate the second document via the first entity.

13. The method of claim 10, wherein obtaining the first information comprises:
providing, for display, graphical elements for inputting one or more non-discretionary parameters for modifying the first document to indicate the second document.

14. The method of claim 10, wherein obtaining the first information comprises:
providing, to one or more server devices, an identifier of an item associated with the first document; and
obtaining, from the one or more server devices, the first information.

15. The method of claim 10, wherein the first entity is associated with a first jurisdiction, and wherein detecting the one or more perfection targets comprises:
determining that the first information indicates that the first document is associated with the first jurisdiction and that an item associated with the first document is registered with a second jurisdiction; and
determining that the first entity is to be associated with the one or more perfection documents based on a level of effort parameter for modifying the first document to indicate the second document associated with:
the one or more perfection documents associated with the first entity and the first jurisdiction, and
another one or more perfection documents associated with a second entity and the second jurisdiction.

16. The method of claim 10, further comprising:
determining a difference between a parameter as indicated by the first information and the parameter as indicated by the second information; and
generating a modification flag to indicate that a perfection document, of the one or more perfection documents, is to be associated with addressing the difference.

17. A non-transitory computer-readable medium storing a set of instructions, the set of instructions comprising:
one or more instructions that, when executed by one or more processors of a device, cause the device to:
obtain first information of a first document;
obtain second information of a second document;
determine, using a rules engine and based on the first information, one or more base documents associated with modifying the first document to indicate the second document;
detect, using the rules engine and based on a comparison of the first information to the second information, one or more perfection targets associated with modifying the first document to indicate the second document;
determine, using an entity database and based on the first information and the second information, one or more perfection documents for the one or more perfection targets,
wherein the one or more perfection documents are provided by a first entity identified using the entity database; and
provide an indication of the one or more base documents and the one or more perfection documents.

18. The non-transitory computer-readable medium of claim 17, wherein the one or more instructions, that cause the device to detect the one or more perfection targets, cause the device to:
determine a difference between a parameter as indicated by the first information and the parameter as indicated by the second information.

19. The non-transitory computer-readable medium of claim 17, wherein the one or more instructions, that cause the device to obtain the first information, cause the device to:
provide, for display, graphical elements for inputting one or more non-discretionary parameters for modifying the first document to indicate the second document.

20. The non-transitory computer-readable medium of claim 17, wherein the one or more instructions, that cause the device to obtain the first information, cause the device to:
provide, to one or more server devices, an identifier of an item associated with the first document; and
obtain, from the one or more server devices, the first information.
